(19) United States
(12) Patent Application Publication
(10) Pub. No.: US 2016/0161973 A1
(43) Pub. Date: Jun. 9, 2016

(54) Driver's Airbrake Safety Enhancement

(71) Applicant: Martin Donald Phillip, Lilburn, GA (US)

(72) Inventor: Martin Donald Phillip, Lilburn, GA (US)

(21) Appl. No.: 14/561,154

(22) Filed: Dec. 4, 2014

(51) Int. Cl. G05G 1/02; B60T 7/10

(52) U.S. Cl. CPC G05G 1/02; B60T 7/10

(57) ABSTRACT

This invention alleviates the agonizing shock of activating a vehicle air brake and acts as a buffer to protect the driver's fingers, arm and shoulder whenever the parking brake is set. This invention consists of a single piece, a ring, or doughnut made of foam rubber or similar durable material so as to cushion the shock of an airbrake when activated.

### BACKGROUND OF THE INVENTION

### Field of Invention

The present invention is in the mechanical electrical computer field, more specifically an airbrake safety enhancement.

### SUMMARY OF THE INVENTION

This invention consists of a doughnut made of foam rubber or similar material which can slip over the shaft of an airbrake knob so as to cushion the shock of the airbrake when it is activated. The airbrake knob can be unscrewed and inserted into this invention through the centered hole making it a whole unit. At such point, one can use the index and middle finger positioned behind the rubber while pulling on the brake giving the airbrake knob a softer touch. Immediately after this invention is installed one feels a great relief from air brake knob vibrations and appreciates the prevention of blisters, calluses, bruises, wrist, arm, and shoulder pains, not excluding carpel tunnel. Repeated application and release of the air brakes causes stress on the hand and wrist, and this ultimately alleviates these problems by cushioning the shock of the air brake application and release.

“Code Section “40-6-165 Prior to loading or unloading passengers from a school bus, the driver shall engage the parking brakes of the bus and shall not release such brakes until each passenger boarding the bus is on board and until each passenger disembarking from the bus is off the roadway and safely on the pedestrian areas of the roadway”

To date the problem is on going because it is engineered and manufactured that way. There are no devices available to dampen the shock of the air brake knob when the air brake is being activated.

Why the Invention is Novel

The current airbrake control knob is made out of hard plastic material attached to a hard hollow plastic pipe that sends a vibration to the drivers' fingers. The construction of this invention cushions the impact. Makes life easier and more convenient for the driver; small and light weight; low manufacturing cost. “This is in no way tampering with the braking system or any part of the normal operation of the bus to cause injury to students or the general public and above all this will not sacrifice the safety of anyone”.

### EMBODIMENT

Different ways this invention can look and work—other than what was described above. Since the airbrake mechanism is designed to ensure the bus is stationary when set to provide safety that makes the invention work in no other way but to pull the knob in conjunction with the foam rubber attached to it. While a typical modality of this invention is a two inch outside diameter and the center diameter ¾ of an inch, and approximately ½ an inch thickness it can take on similar dimension or color, and its shape can be any, as long as the scope, purpose, and function are maintained. The above description and uses are what one can expect to see normally in this invention, but there may be variations, which are presently described.

This description of my Drivers Airbrake Safety Enhancement gives a ‘person having an ordinary skill level in the art (35 USC 103(a))’ the ability to create and use the device in the best way possible. There can be variations, equivalents, and combinations of the device, so one should not take the above description as being the only way or form it can be created. That is, this description is but one representation of what can be done to produce the device to perform in the intended manner.

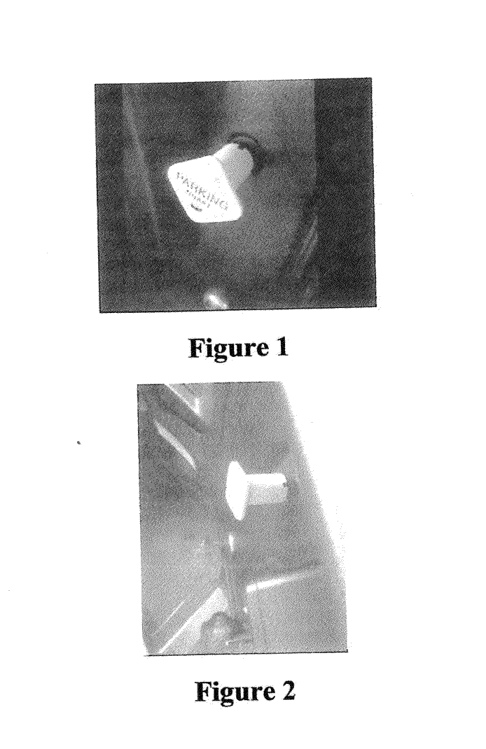

FIG. 1 is a front-side view photograph of a typical air brake knob in a bus, illustrating that the shock of the air braking is transmitted through an inflexible hard plastic directly to the fingers.

FIG. 2 is a side view photograph of a typical air brake knob in a bus, illustrating that the shock of the air braking is transmitted through an inflexible hard plastic directly to the fingers.

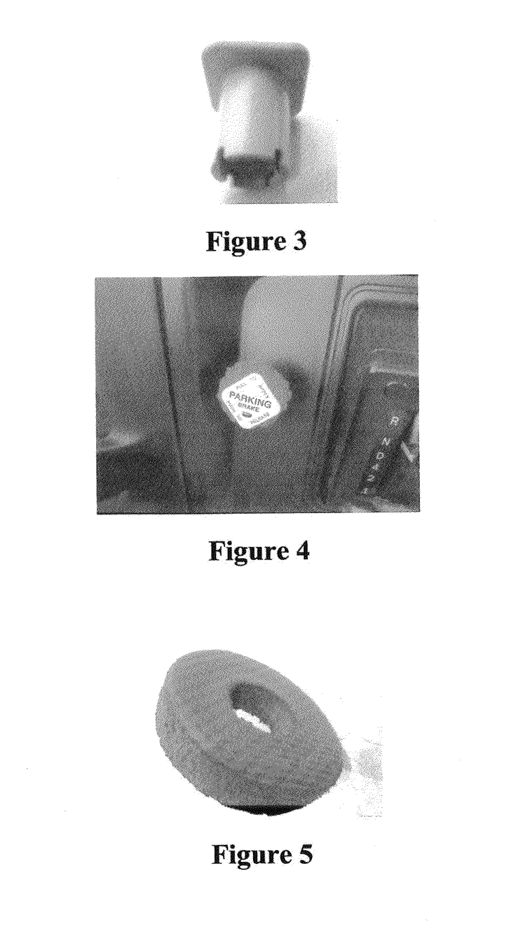

FIG. 3 is a side view photograph of a typical air brake knob by itself, illustrating that the shock of the air braking is transmitted through an inflexible hard plastic directly to the fingers.

FIG. 4 is a photograph of a current but ineffective manner of buffering the shock of a typical air brake knob in a bus. The fabric enclosure is insufficient to buffer the shock effectively.

FIG. 5 is a front-side angled view photograph of this invention.

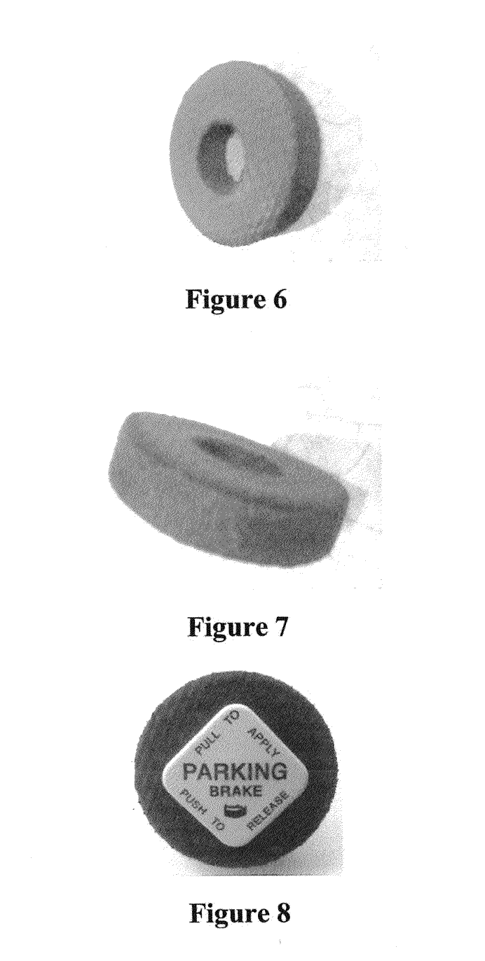

FIG. 6 is a front-side view photograph of this invention.

FIG. 7 is a flattened front-side angled view photograph of this invention.

FIG. 8 is a front view photograph of this invention installed on the air brake knob, itself.

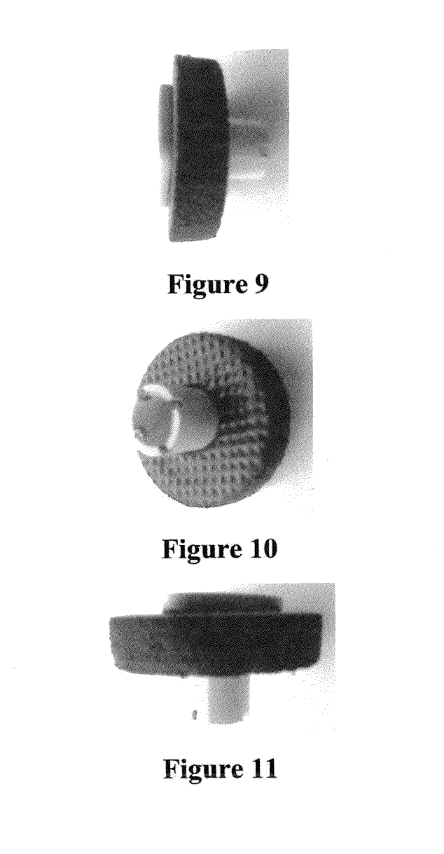

FIG. 9 is a side view photograph of this invention installed on the air brake knob, itself.

FIG. 10 is an underneath view photograph of this invention installed on the air brake knob, itself.

FIG. 11 is a side view photograph of this invention installed on the air brake knob, itself.

FIG. 12 is a photograph of this invention beside the air brake knob, itself.

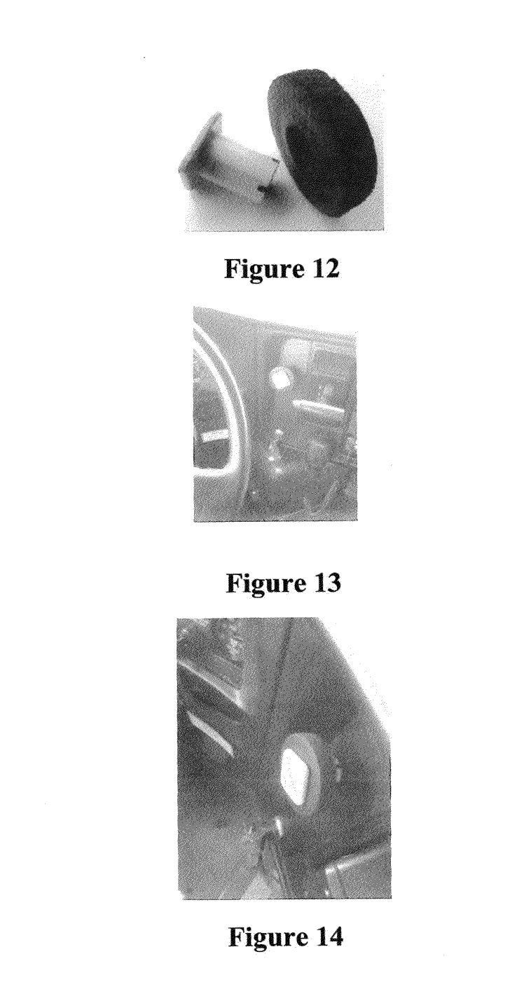

FIG. 13 is a front view photograph of this invention installed on the air brake knob in a bus.

FIG. 14 is a side angle view photograph of this invention installed on the air brake knob in a bus.

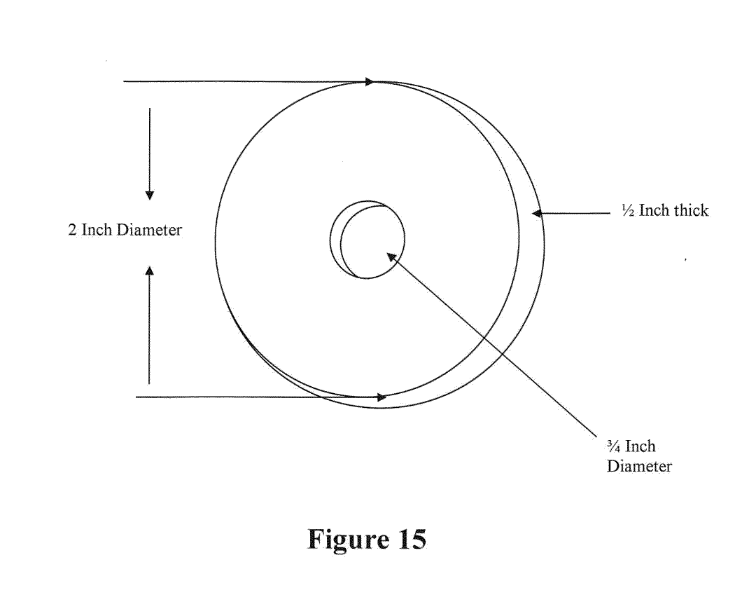

FIG. 15 describes the dimensions of this invention.

What is claimed is:

1. An airbrake knob accessory configured for use with a vehicle airbrake knob to protect drivers' fingers from airbrake knob shock. The airbrake knob accessory is operable mounted on the parking brake knob engaging a pipe shaft mechanism attached to the airbrake knob in order to render a vehicle stationary.

2. The airbrake knob accessory of claim 1 the rubber body comprises a rubber spherical made of foaming rubber and a hollow-shaped positioned centered through the ½ inch thick foaming rubber and provide ample support which takes away the impact of the vibration when the parking brake is set.

3. The airbrake knob accessory of claim 1 consequently, setting and releasing a school bus parking brake multiple times in a workday using a push/pull valve eventually leave drivers with stress and seriously injured arms, shoulders, elbows, and/or wrists, including carpel tunnel.

4. The airbrake knob accessory of claim 2 with a rubber ring made of foaming rubber can be mounted on the airbrake knob can also take on a different shape or color on one external side and also on the other side and has the capability of maintaining the same end result.

5. The airbrake knob accessory method of claim 4 further comprise when applying sufficient contact pressure to airbrake knob accessory and airbrake knob as a whole, making both units when mounted on said shall makes a complete assembly.
